(19) United States
(12) Patent Application Publication
(10) Pub. No.: US 2024/0331315 A1
(43) Pub. Date: Oct. 3, 2024

(54) METHOD FOR ASCERTAINING A CONFIGURATION OF A USER-STATE-DEPENDENT OUTPUT OF INFORMATION FOR A USER OF AN AR DEVICE, AND AR DEVICE

(71) Applicant: Robert Bosch GmbH, Stuttgart (DE)

(72) Inventor: Andreas Heyl, Weil Der Stadt (DE)

(21) Appl. No.: 18/607,240

(22) Filed: Mar. 15, 2024

(30) Foreign Application Priority Data
Mar. 28, 2023 (DE) 10 2023 202 839.5

(51) Int. Cl. G06T 19/00; G02B 27/01; G06F 3/01

(52) U.S. Cl. CPC G06T 19/006; G02B 27/0172; G06F 3/013; G02B 2027/0178; G06T 2210/21

(57) ABSTRACT

A method for ascertaining a configuration of a user-state-dependent output of safety-relevant and non-safety-relevant information for a user of an AR device, in particular a pair of AR glasses. The method includes: receiving first data, wherein the first data are specific to at least one object in an, in particular indirect and/or direct, environment of the user; receiving second data, wherein the second data are specific to the user; ascertaining a safety relevance of the at least one object to the user on the basis of the first data and/or the second data; ascertaining a state of the user on the basis of the second data; generating an output signal to the AR device depending on the ascertained safety relevance and the ascertained state of the user.

### CROSS REFERENCE

The present application claims the benefit under 35 U.S.C. § 119 of German Patent Application No. DE 10 2023 202 839.5 filed on Mar. 28, 2023, which is expressly incorporated herein by reference in its entirety.

### FIELD

The present invention is based on a method for ascertaining a configuration of a user-state-dependent output of safety-relevant and non-safety-relevant information for a user of an AR device.

### BACKGROUND INFORMATION

German Patent Application No. DE 10 2019 214 283 A1 describes a method for processing an image recorded by a camera, wherein, in a transformation mode, the image is subjected to a specified transformation and displayed to a user on a display unit, and the transformation mode is left in the case of a specified event.

### SUMMARY

The present invention provides a method for ascertaining a configuration of a user-state dependent output of information for a user of an AR device, a device, and a computer program.

According to an example embodiment of the present invention, the method for ascertaining a configuration of a user-state-dependent output of safety-relevant and non-safety-relevant information for a user of an AR device, in particular a pair of AR glasses, has the following steps. An AR device can here be understood to mean a device which can represent an augmented reality (AR) to the user in that additional information, which, for example, visually, auditively or haptically augments the user's reality perception, is output to the user, in particular in a computer-aided manner.

The method comprises a step of receiving first data, wherein the first data are specific to at least one object in an, in particular indirect and/or direct, environment of the user. In other words, the first data contain information on the object and information on whether and to what extent the object will or could interact with the user and could represent a potential danger to the user.

In addition, the method has a step of receiving second data, wherein the second data are specific to the user. In this way, an, in particular instantaneous, specific situation of the user within their environment can be taken into account in ascertaining the safety relevance of the at least one object to the user.

Furthermore, the method has a step of ascertaining a safety relevance of the at least one object to the user on the basis of the first data and/or the second data. In other words, the first data and/or the second data are evaluated, for example on the basis of a comparison with similar existing data, or by means of a specifically trained neural network, as to whether the object represents a danger to the user and how great this danger is.

Furthermore, the method has a step of ascertaining a state of the user on the basis of the second data. The state of the user can inter alia be understood to mean whether the user is moving or not, whether the user is inside or outside a building, or whether the user is currently resting or actively engaged in work or an activity.

Furthermore, the method has a step of generating an output signal to the AR device. In this case, the output signal is generated depending on the ascertained safety relevance and the ascertained state of the user. In other words, depending on the degree of a danger to the user (e.g., low, medium or high) and depending on the possibility of the user influencing their, in particular instantaneous, situation, a different type of representation of the information that can be output or is to be output by the AR device to the user can take place.

Thus, in one embodiment of the present invention, in the case of a low danger level, the AR device can output both non-safety-relevant information and possibly safety-relevant information regarding the at least one object to the user equally. In the case of a medium danger level, the AR device can, for example, output non-safety-relevant information to only a limited extent or less prominently than safety-relevant information regarding the at least one object to the user. In the case of a high danger level, it can be provided that the AR device no longer outputs non-safety-relevant information to the user or outputs it only to a very limited extent, and only outputs the safety-relevant information regarding the at least one object. In this case, this safety-relevant information can also advantageously be output to the user in a prominently highlighted manner. However, if the state of the user is such that the user does not have any possibility of influencing their, in particular instantaneous, situation, it can also be provided that both non-safety-relevant information and the possibly safety-relevant information regarding the at least one object are output equally.

This can ensure that the user is warned in the case of situations dangerous to them, that the user can also direct their focus to the potential danger and is not distracted by non-safety-relevant information, if the user's state allows them to influence their, in particular instantaneous, situation. It is thus possible for the user to use the AR device even in potentially dangerous situations without having to completely dispense with a functionality of the AR device. The safety of the user of the AR device, for example as a participant in road traffic, but also the safety of other persons in the environment of the user can thereby be significantly increased. In addition, the functionality for the user can be provided even more precisely by including the user state. For example, the user does not have to dispense with the representation of their favored non-safety-relevant information if the user has no influence on their, in particular instantaneous, situation anyway.

Further advantages of the present invention are disclosed herein.

In a preferred embodiment of the present invention, it is provided that the second data are specific to a type of use of a further device, in particular a vehicle or a machine. A further device can be understood to mean a vehicle, preferably a motor vehicle, in particular a passenger car, a truck, a motorcycle, a bicycle, a public transport means or the like, or a machine, in particular within the scope of an industrial production method or within the scope of a do-it-yourself activity or the like. A type of use of the further device can inter alia be understood to mean that the user actively operates the further device, for example as a vehicle driver or machine operator, or only passively uses it, for example as a front-seat passenger or fellow passenger of a vehicle or as a controller of the machine who must or can intervene in an operation of the machine only under certain conditions. In this way, the output of safety-relevant and non-safety-relevant information can be configured in a particularly efficient manner. If, for example, the second data contain information that the user is currently controlling a vehicle, this information, on the one hand, conditions the safety relevance and, on the other hand, the possibility of the user influencing their, in particular instantaneous, situation. Therefore, in such a case, the output signal can be generated in such a way that the AR device outputs non-safety-relevant information to a limited extent or less prominently than safety-relevant information regarding the at least one object to the user.

In contrast, if the second data, for example, contain information that the user is only a front-seat passenger in a vehicle, the user has (at least no direct) possibility of influencing their, in particular instantaneous, situation. Therefore, in such a case, the output signal can be generated in such a way that the AR device continues to output non-safety-relevant information without limitations to the user or does not even output any safety-relevant information regarding the at least one object or outputs it only to a limited extent.

In a further preferred embodiment of the present invention, it is provided that the second data are specific to a physiological and/or psychological state of the user. This can, for example, be understood to mean a degree of attention, a degree of fatigue, or other vital signs of the user. The safety relevance of the at least one object to the user can thereby be determined even more accurately, and the type of the output signal can be adapted accordingly. For example, a tired user or a user whose attention is currently obviously not directed to the at least one object can thus be made aware of the object or the associated danger in a particularly noticeable manner. On the other hand, a user who seems more observant, energetic and/or alert anyway does not have to be unnecessarily disturbed by particularly noticeable visual, auditive and/or haptic outputs in order to be made aware of the object or the associated danger.

Furthermore, a physiological and/or psychological state of the user can be understood to mean a user intention. The user intention may, for example, represent an active intent of the user to use or not to use the AR device or may represent an active intent of the user to complete a particular action, such as crossing a road, for example. Alternatively, the user intent can also be based on an estimation as to whether the user will use the AR device or not.

Furthermore, according to an example embodiment of the present invention, it is advantageous if the second data are specific to an, in particular instantaneous, gaze direction of the user. This is because, in this way, it can be determined in a particularly simple and robust manner whether the attention of the user is directed to the at least one object.

In a further preferred embodiment of the present invention, it is provided that the AR device outputs safety-relevant information regarding the at least one object with a higher priority than non-safety-relevant information if the state of the user exceeds a determined or determinable value, for example a determined degree of fatigue, or falls below a certain degree of attention, for example. As a result, it is possible to define a certain tolerance range in which the AR device is operated without limitation, in particular without the prioritization of the output of safety-relevant information regarding the at least one object and non-safety-relevant information. In addition, this tolerance range can be defined by the user beforehand. This is advantageous in particular if several different users use the AR device.

Alternatively or additionally, according to an example embodiment of the present invention, it can advantageously be provided that the AR device outputs safety-relevant information regarding the at least one object with a higher priority than non-safety-relevant information if the second data reveal that the user is using a device, in particular a vehicle or a machine.

In a further preferred embodiment of the present invention, it is provided that the step of ascertaining the safety relevance comprises a determination of a probability of a collision of the user with the at least one object and/or a probability of a particular degree of severity of a consequence of an accident for the user and/or for further persons in the environment of the user in the event of the collision of the user with the at least one object. This is because the safety relevance and thus the specific danger to the user and/or to the further persons in the environment of the user can thereby be ascertained in a simple manner, and the AR device can be controlled by means of the corresponding output signal.

Furthermore, according to an example embodiment of the present invention, it is advantageous if the output signal is output if the safety relevance of the at least one object exceeds a determined or determinable value. It is thus also possible here to define a certain tolerance range in which the AR device is operated without limitation, in particular without the prioritization of the output of safety-relevant information regarding the at least one object and non-safety-relevant information. In addition, this tolerance range can be defined by the user beforehand. This is advantageous in particular if several different users use the AR device.

In a further preferred embodiment of the present invention, it is provided that the output of safety-relevant and non-safety-relevant information is information to be visually represented to the user by means of the AR device in a field of vision of the user, and that, in the step of generating, the output signal is output to the AR device in such a way that non-safety-relevant information is represented only in subareas of the field of vision of the user that are outside an object visibility area, in which subareas the user can visually detect the object and/or in which subareas no safety-relevant information regarding the at least one object is represented. In other words, the field of vision of the user can thereby be kept free of non-safety-relevant information so that, in the case of a dangerous situation, the focus or a concentration of the user is directed to the object or maintained and the user is not unnecessarily distracted by non-safety-relevant information.

Furthermore, according to an example embodiment of the present invention, it is advantageous if the safety-relevant information regarding the at least one object is output to the user in a visually, acoustically, and/or haptically marked manner. For example, in the case of an ascertained medium or high danger, the object can be bordered or shaded in color in the field of vision of the user. Alternatively or additionally, the user can be made aware of the object by an indicative tone or by a vibration pulse. In the case that the object is obscured for the user and thus is not or not yet perceptible, it can be provided that the output signal controls the AR device in such a way that the AR device outputs an acoustic indication to the user (e.g., “Caution! Danger from the left rear”). As a result, an attention of the user can be directed even more specifically to possible dangers, and an accident risk can be further reduced.

In a preferred embodiment of the present invention, it is provided that, before the step of generating the output signal, a step of transforming takes place, wherein the at least one safety-relevant object in the environment of the user is continuously transformed into a coordinate system of the user and/or of the AR device. This ensures that, even during a relative movement between the user and the object, the object and/or the safety-relevant information regarding the at least one object can also be moved and highlighted in the field of vision of the user.

In a further embodiment of the present invention, it is provided that the first data specify a type and/or nature of the at least one object, an, in particular instantaneous, distance between the user and the at least one object, an, in particular instantaneous, velocity of the at least one object, and/or a predicted trajectory of the object in the environment of the user. A type of the object can, for example, be understood to mean that the object is a thing, such as a motor vehicle, a bicycle, a curb, a streetlight, an open manhole or the like, or a living being, such as a further person or an animal. A nature of the object can, for example, be understood to mean a particular size (greater than, smaller than or of a similar size to the user), a particular geometry, and/or a particular material (hard or soft). As a result, the probability of a collision of the user with the at least one object and/or the probability of a particular degree of severity of a consequence of an accident for the user and/or for further persons in the environment of the user in the event of the collision of the user with the at least one object can be determined in a simple and robust manner. For example, there is a lower probability of a collision with the user and thus a lower safety relevance for a streetlight that is detected as an object and has a distance of more than 10 m from the user than for a bicyclist who has a distance of 20 m from the user and is traveling directly toward the user at a speed of 15 km/h. In an analogous manner, the probability of a high degree of severity of a consequence of an accident in the event of the collision of the user with a bicyclist who is traveling directly toward the user at a speed of 15 km/h will be higher than in the event of the collision of the user with the bicyclist who is traveling directly toward the user at a speed of 8 km/h.

Furthermore, according to an example embodiment of the present invention, it can be provided that the second data additionally contain information on an instantaneous position, an instantaneous velocity, and/or a predicted trajectory of the user in their environment. The safety relevance of the at least one object to the user can thereby be determined even more precisely.

In a further preferred embodiment of the present invention, it is provided that the first data and/or second data are data that are or can be detected by an internal sensor system of the AR device. The data can thereby be detected in a particularly simple and energy-saving manner.

The internal sensor system can, for example, be designed as an inertial sensor, as an optical sensor, preferably as a camera, as a gaze direction detection unit, as a gaze direction tracking unit, or as a LIDAR sensor, as a RADAR sensor or as an ultrasonic sensor.

Alternatively or additionally, according to an example embodiment of the present invention, it can be provided that the first data and/or second data are data that are or can be detected by an external sensor system that can be or is connected in terms of signaling to the AR device. In this case, the first data and/or second data can be obtained by a distributed system of external sensors, which are, for example, arranged on stationary roadside units (RSUs), on vehicles in the environment of the user, or are integrated in electronic devices of further persons in the environment of the user, in particular in their smartphones or AR devices. In this way, redundancy can be generated, and more robust data can thus be obtained, which has the result that the safety relevance is ascertained more accurately.

The external sensor system can, for example, be designed as an optical sensor, preferably as a camera, as a gaze direction detection unit, as a gaze direction tracking unit, or as a LIDAR sensor, as a RADAR sensor or as an ultrasonic sensor.

It can particularly preferably be provided that the step of ascertaining the safety relevance to the user is carried out by an external unit, which is connected in terms of signaling to the AR device. In this case, a so-called digital twin can be generated to represent the user for whom the safety relevance is ascertained, which safety relevance is then transmitted to the AR device.

The aforementioned advantages also apply in a corresponding manner to a device, in particular for data processing, which is configured to perform the method according to one of the embodiments of the present invention described above.

For example, the device can have a control unit, wherein the control unit is configured to carry out at least one of the steps of one of the methods according to the above-described embodiments of the present invention.

In this case, the method can, for example, be implemented in software or hardware or in a mixed form of software and hardware in the device and/or the control unit. For this purpose, the device and/or the control unit may have at least one evaluation unit for processing signals or data, at least one memory unit for storing signals or data, at least one interface to a detection unit or an actuator for reading sensor signals or characteristic variables from the detection unit or for outputting control signals to the actuator, and/or at least one communication interface for reading or outputting data embedded in a communication protocol. The evaluation unit can, for example, be a signal processor, a microcontroller or the like, wherein the memory unit can be a flash memory, an EPROM, or a magnetic memory unit. The communication interface can be designed to read or output data wirelessly and/or in a wired form, a communication interface, which can read or output wired data, being able to read these data, for example electrically or optically, from a corresponding data transmission line, or being able to output these data into a corresponding data transmission line.

According to an example embodiment of the present invention, preferably, the device is designed as an AR device or comprises an AR device. As a result, the safety-relevant and non-safety-relevant information can be output to the user in a simple manner, namely, in a manner superimposed on the user's environment detected in a visual, auditive or haptic manner.

According to an example embodiment of the present invention, particularly preferably, the AR device can be designed as a pair of AR glasses or as a head-up display in a vehicle. In this case, the corresponding information can, for example, be visually superimposed in the field of view of the user field of view.

The present invention also relates to a computer program product or a computer program with program code that can be stored on a machine-readable, in particular non-volatile, carrier or storage medium, such as a semiconductor memory, a hard disk memory, or an optical memory, and that is used to carry out, implement and/or control the steps of the method according to one of the embodiments of the present invention described above, in particular when the program product or program is executed on a computer or a device according to one of the embodiments of the present invention described above.

The present invention also relates to a computer-readable storage medium that comprises the computer program. The storage medium is designed, for example, as a data store such as a hard drive and/or a non-volatile memory and/or a memory card. The storage medium may, for example, be integrated into the computer or a device according to one of the embodiments of the present invention described above.

### BRIEF DESCRIPTION OF THE DRAWINGS

Exemplary embodiments of the present invention are shown schematically in the figures and explained in more detail in the following description. The same reference signs are used for the elements shown in the various figures and acting similarly, whereby a repeated description of the elements is dispensed with.

FIG. 1 shows a schematic representation of a method, a device and a computer program according to exemplary embodiments of the present invention

FIG. 2-4 show flow charts for illustrating the method according to further exemplary embodiments of the present invention.

FIG. 5 shows a schematic representation for visualizing the present invention according to an exemplary embodiment of the present invention.

FIG. 6 shows a schematic representation for visualizing the present invention according to a further exemplary embodiment of the present invention.

### DETAILED DESCRIPTION OF EXAMPLE EMBODIMENTS

As already stated above, the present invention describes a method, a device and a computer program, which make it possible, by taking into account the state of a user of an AR device, to direct the attention of the user to a potential danger, without distracting the user by non-safety-relevant information.

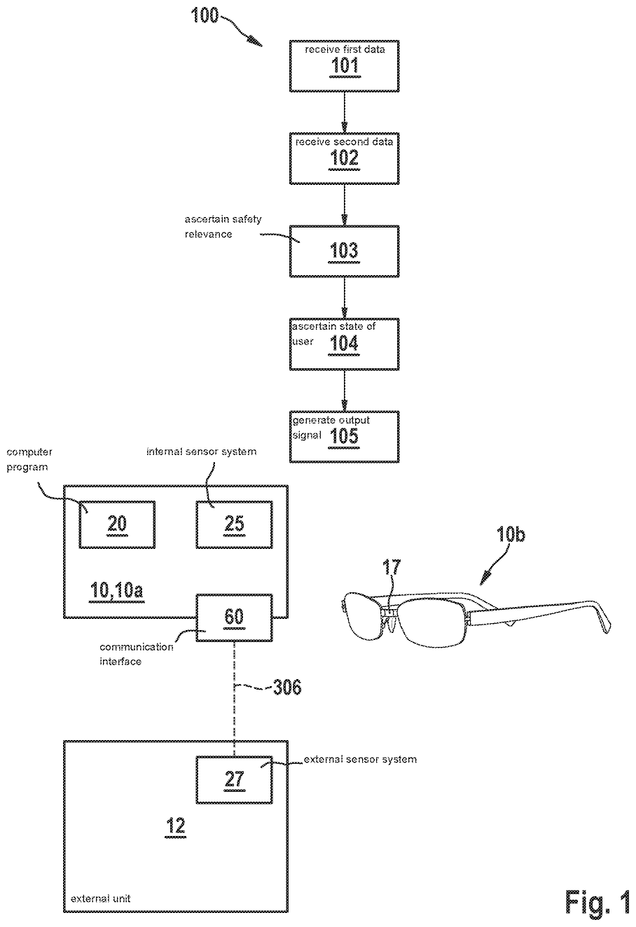

FIG. 1 illustrates, according to exemplary embodiments of the present invention, a method 100 for ascertaining a configuration of a user-state-dependent output of safety-relevant and non-safety-relevant information for a user of an AR device 10a, wherein the AR device 10a can be designed as a pair of AR glasses 10b or as a head-up display in a vehicle. The AR device 10a, the AR glasses 10b or the head-up display can advantageously comprise a sensor system 17 for gaze direction detection and/or gaze direction tracking, with which eyes, eye movements and/or gaze directions of the user can be detected and continuously tracked.

According to a first method step 101, first data can be received, wherein the first data are specific to at least one object 80, 82 in an, in particular indirect and/or direct, environment of the user. Subsequently, according to a second method step 102, second data can be received, wherein the second data are specific to the user. The second data can, for example, indicate whether the user is in or outside a vehicle, whether the user is actively driving the vehicle or Is only a front-seat passenger and, in the case of the user actively driving the vehicle, whether the user is tired or distracted or whether the user is energetic, rested and focused on all possible dangers occurring in the traffic situation. The first data and/or second data can, for example, be detected by an internal sensor system 25 of the AR device 10, in particular by an inertial sensor, by an optical sensor, preferably a camera, a LIDAR sensor or the sensor system 17 for gaze direction detection and/or gaze direction tracking, by a RADAR sensor or by an ultrasonic sensor. It can also be provided that the first data and/or second data are detected by an external sensor system 27 that can be or is connected in terms of signaling to the AR device 10a, in particular by an optical sensor, preferably a camera, a LIDAR sensor, or a sensor system for gaze direction detection and/or gaze direction tracking, by a RADAR sensor or by an ultrasonic sensor. In a third method step 103, a safety relevance of the at least one object 80, 82 to the user can be ascertained on the basis of the first data. Step 103 may alternatively or additionally take place taking into account the second data. In particular, step 103 may alternatively or additionally be carried out by an external unit 12, which is connected in terms of signaling to the AR device 10a. In this case, a so-called digital twin can be generated to represent the user for whom the safety relevance is ascertained, which safety relevance is then transmitted to the AR device 10a. In method step 103, a probability of a collision of the user with the at least one object 80, 82 and/or a probability of a particular degree of severity of a consequence of an accident for the user and/or for further persons in the environment of the user in the event of the collision of the user with the at least one object 80, 82 can be determined. According to a fourth method step 104, a state of the user can then be ascertained on the basis of the second data. According to a fifth step 105, an output signal to the AR device 10a can be generated depending on the ascertained safety relevance and the ascertained state of the user. This method step 105 can take place in such a way that the AR device 10a outputs safety-relevant information regarding the at least one object 80, 82 with a higher priority than non-safety-relevant information. In this case, the safety-relevant information can additionally be highlighted by flashing or by another visual, auditive and/or haptic warning, taking into account the detected gaze direction of the user.

The method steps 101-105 can in this case be performed by a device 10. The device 10 is, for example, a computer, and/or a device 10 for data processing, and/or a control unit, and/or the like and comprises a communication interface 60 for, in particular wireless, networking (306) with further devices, units, or the like. Furthermore, the device 10 can have a computer program 20 according to exemplary embodiments of the present invention. The device 10 can also be designed as the AR device 10a, in particular as the pair of AR glasses 10b or as the head-up display, or can comprise the AR device 10a, in particular the pair of AR glasses 10b or the head-up display.

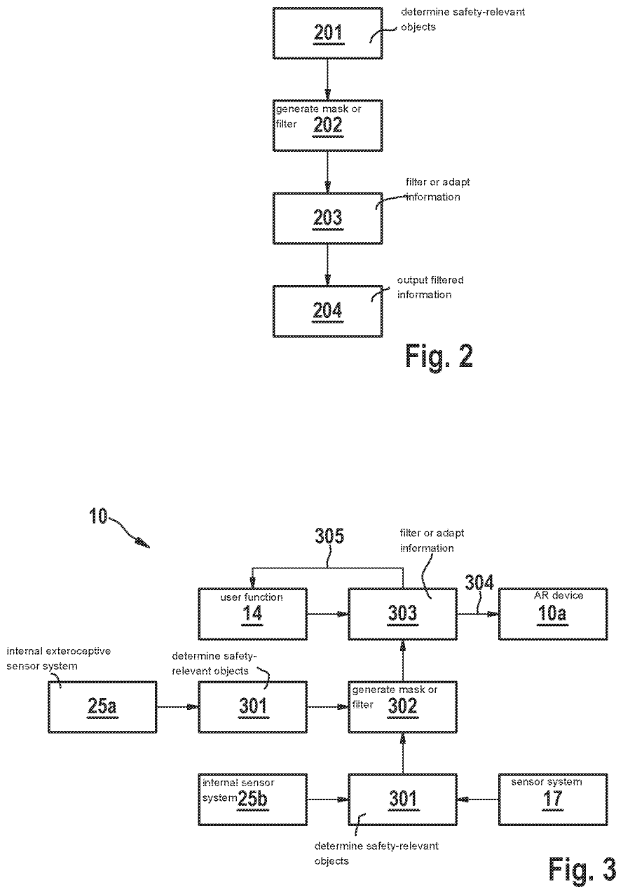

FIG. 2 visualizes a further exemplary sequence on the basis of a flow chart. According to a first step 201, safety-relevant objects 80, 82 in the environment of the user or of the AR device 10a can be determined. This can, for example, take place by determining the situation and by determining the safety criticality. The situation can, for example, be determined by generating an environmental model on the basis of the internal exteroceptive sensor system and optionally additionally on the basis of information from an external sensor system (digital twin). These external sensor data can, for example, comprise data on infrastructure, vehicles, AR devices (e.g., for objects), models of the environment (motion models, weather models, road models (e.g., for behavior prediction, friction coefficients, etc.)), information from other agents (e.g., behavior intention, warnings, maneuver coordination message, etc.).

The safety criticality of the objects 80, 82 or elements themselves or the associated risk can be determined dependent on the probability that, in the future, a hazard for the user comes therefrom, for example through a collision, and on the severity of this event (for the user but also for others). For this purpose, detailed models can advantageously be used both for the prediction of future states (of the user and of the environment) and for the severity assessment of events. Corresponding models and functions are currently being developed for use in autonomous vehicle systems and can also be used for use in AR glasses. Furthermore, an ML module, e.g., a deep neural network (DNN), trained with a sufficient amount of data and validated can, for example, be used for the assessment of the situation. In both approaches, it is important to also predict the behavior and the future state of the user. For this purpose, it is inter alia determined how the user is currently moving, e.g., on foot, by bicycle, in a vehicle. In addition, a more detailed motion model of the user (straight, zigzag, fast/slow) can also be used.

For determining the safety criticality, simpler calculation methods only on the basis of distances, relative velocities, and detected lane courses of both the user and the object 80, 82 are however also possible (e.g., on the basis of time-to-collision, RSS1). For example, the safety criticality of far-away areas is in principle not as high as for areas directly in front of the user, since the user has more time to react to dangers from this area.

In the determination of the safety criticality, it can furthermore also be taken into account whether the user is actively driving a vehicle or is only a front-seat passenger and, in the case of the user actively driving the vehicle, whether the user is tired or distracted or whether the user is energetic, rested and focused on all possible dangers occurring in the traffic situation. If the user is the vehicle driver and tired, the object 80, 82 poses a greater danger than if the user is the vehicle driver and alert and focused. If the user is not a vehicle driver but only a fellow passenger or front-seat passenger, the user can also deactivate the filtering or adaptation described in step 203 below.

The determination of the safety criticality may alternatively or additionally take place in an external device or computing unit (digital twin). In this case, the safety-relevant objects 80, 82, elements, events or areas are subsequently provided to the AR device 10a by the digital twin. The transmission takes place via the wireless communication either only on request by the AR device 10a or continuously by broadcast/pub-sub.

According to a second step 202, a mask or a filter can be generated for the information to be output to the user via the AR device 10a. In this case, a mask for the safety-relevant objects 80, 82, elements or areas in the environment is then generated in the AR device 10a relative to the AR device 10a and the sensory system of the user (in particular eyes, but also ears) on the basis of the information determined in the previous step (internally or by the digital twin). That is to say, the safety-relevant objects 80, 82 or areas to be masked are located in the coordinate system of the world; the mask transforms this to the coordinate system of the AR device 10a and carries along this transformation continuously with the movement of the AR device 10a.

Alternatively, the mask can already be generated or calculated in the digital twin. For this purpose, the exact positioning of the AR device 10a is determined either externally by the digital twin or through pose information transmitted directly from the AR device 10a to the digital twin.

According to a third step 203, a filtering or an adaptation of the information to be output to the user can take place. For this purpose, the mask can be used to filter display data, which the AR device 10a generates on the basis of functions selected by the user (e.g., representation of Pokémon figures, AR arrows for navigation, TikTok videos, etc.), such that they do not obscure any safety-relevant areas in the environment of the user (relative to the user or sensory system (eyes, ears)). Optionally, the information on the filtered areas can be returned to a user function 14 so that the user function 14 can adapt its representation such that the safety-relevant areas are not used for the display. In particular, a sensor system 17 for gaze direction detection or gaze direction tracking can be used in this case in order to determine the instantaneous gaze direction of the user and thus a degree of distraction of the user from any danger and to adapt, in a more specific manner, the information to be output to the user.

According to a fourth step 204, the filtered information can be output to the AR device 10a so that only the filtered AR data or AR information is displayed to the user. The user thus has a clear view of the safety-relevant objects 80, 82, elements, events or areas in their environment.

FIG. 3 shows a further exemplary sequence of the method within the device 10 on the basis of a block diagram. According to a first step 301, safety-relevant objects 80, 82 in the environment of the user or of the AR device 10a can be determined. For this purpose, first data are detected by an internal exteroceptive sensor system 25a. Furthermore, in the first step 301, a position and/or orientation of the AR device 10a relative to the environment of the user or relative to the sensory system of the user (in particular eyes, but also ears) can be determined by detecting second data by means of an internal sensor system 25b, wherein the internal sensor system 25b is preferably designed as an inertial sensor system. In this case, it can also be detected whether the user is in a vehicle and, if the user is in the vehicle, whether the user is driving the vehicle or whether the user is a front-seat passenger. Furthermore, the first step 301, a physiological and/or psychological state, in particular a degree of attention or a degree of fatigue, of the user can be determined by detecting second data by means of a sensor system 17 for gaze direction detection and/or gaze direction tracking. According to a second step 302, a mask or a filter can be generated for the information to be output to the user via the AR device 10a. In this case, a mask for the safety-relevant objects 80, 82, elements or areas in the environment is then generated in the AR device 10a relative to the AR device 10a and the sensory system of the user (in particular eyes, but also ears) on the basis of the information determined in the previous step. According to a third step 303, a filtering or an adaptation of the information to be output to the user can take place in such a way that safety-relevant information is not superimposed or even covered by non-safety-relevant information, provided that the state of the user, for example as the driver of the vehicle, requires this. For this purpose, the mask can be used to filter display data, which the AR device 10a generates on the basis of functions selected by the user (e.g., representation of Pokémon figures, AR arrows for navigation, TikTok videos, etc.), such that they do not obscure any safety-relevant areas in the environment of the user (relative to the user or sensory system (eyes, ears)). According to a fourth step 304, the filtered information can be output to the AR device 10a so that only the filtered AR data or AR information is displayed to the user. Optionally, the information on the filtered areas can be returned (indicated by arrow 305) to the user function 14 so that the user function 14 can adapt its representation such that the safety-relevant areas are not used for the display.

FIG. 4 shows a further exemplary sequence of the method within the device 10 on the basis of a block diagram. This is an alternative to the embodiment described in FIG. 3, in which the determination of the situation (301) takes place (301a) in an external unit 12, the digital twin, by generating the environmental model on the basis of data that are detected by means of the external sensor system 27, external information 28 and/or external models 29. Furthermore, the safety criticality is also determined in the digital twin. In this case, the safety-relevant objects 80, 82, elements, events or areas are subsequently provided by the digital twin (301b) to the device 10 or the AR device 10a by means of a wireless connection (306). Furthermore, in this case, a position and/or orientation of the AR device 10a relative to the environment of the user or relative to the sensory system of the user (in particular eyes, but also ears) can be determined by detecting (301c) second data by means of an internal sensor system 25b, wherein the internal sensor system 25b is preferably designed as an inertial sensor system. In particular, in this case, a physiological and/or psychological state, in particular a degree of attention or a degree of fatigue, of the user can be determined by detecting the second data by means of a sensor system 17 for gaze direction detection and/or gaze direction tracking.

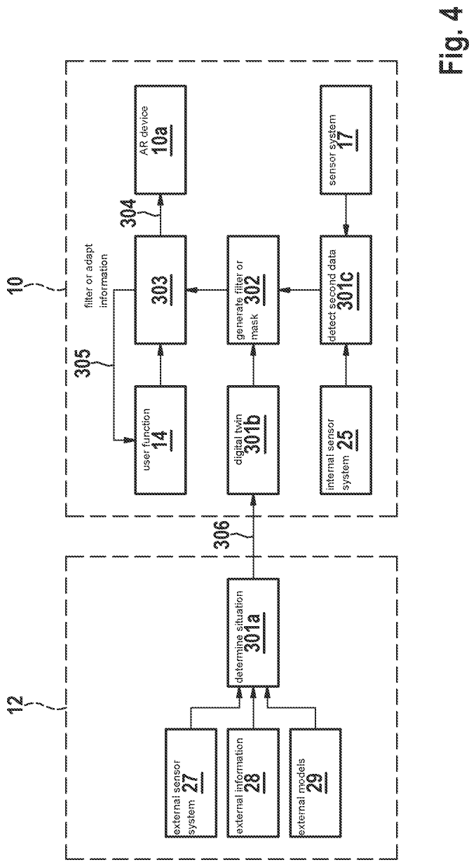

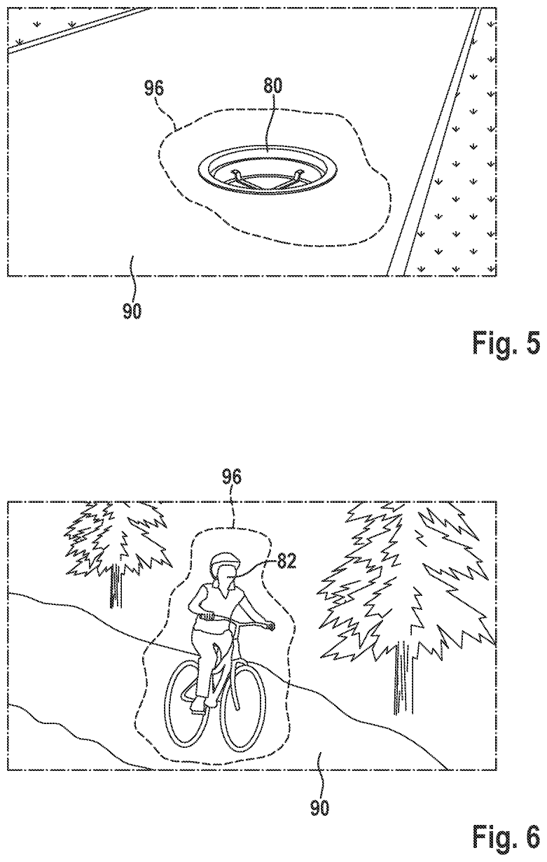

FIGS. 5 and 6 are schematic representations for visualizing the present invention according to two exemplary embodiments. FIG. 5 shows a detail of a field of vision 90 of the user of the AR device 10a, which detail shows a portion of a road 85 with a manhole 80a without a manhole cover as the object 80 that is safety-relevant to the user. The device 10 or the AR device 10a recognizes that the manhole 80a represents a danger to the user recognized as an, in particular tired, vehicle driver and generates a mask 96 around the manhole 80a in such a way that, in the AR representation shown to the user, the area around the manhole 80a is kept free of non-safety-relevant information and/or is visually marked. In the rest of the area of the field of vision 90 of the user, the AR device 10a can continue to display non-safety-relevant information to the user.

FIG. 6 shows a detail of a field of vision 90 of the user of the AR device 10a, which detail shows a forest path with a bicyclist 82a as the object 82 that is safety-relevant to the user. The device 10 or the AR device 10a recognizes that the bicyclist 82a represents a danger to the user recognized as an, in particular unobservant, walker and generates a mask 96 around the bicyclist 82a in such a way that, in the AR representation shown to the user, the area around the bicyclist 82a is kept free of non-safety-relevant information and/or is visually marked. In the rest of the area of the field of vision 90 of the user, the AR device 10a can continue to display non-safety-relevant information to the user.

What is claimed is:

1. A method for ascertaining a configuration of a user-state-dependent output of safety-relevant and non-safety-relevant information for a user of an AR device, comprising the following steps:
receiving first data, wherein the first data are specific to at least one object in an indirect and/or direct environment of the user;
receiving second data, wherein the second data are specific to the user;
ascertaining a safety relevance of the at least one object to the user based on the first data and/or the second data;
ascertaining a state of the user based on the second data; and
generating an output signal to the AR device depending on the ascertained safety relevance and the ascertained state of the user.

2. The method according to claim 1, wherein the AR device is a pair of AR glasses.

3. The method according to claim 1, wherein the second data are specific to a type of use of a further device, the further device being a vehicle or a machine.

4. The method according to claim 1, wherein the second data are specific to a physiological and/or psychological state, the physiological and/or psychological state in including a degree of attention of the user.

5. The method according to claim 1, wherein the second data are specific to an instantaneous gaze direction of the user.

6. The method according to claim 1, wherein the AR device outputs safety-relevant information regarding the at least one object with a higher priority than non-safety-relevant information when the state of the user exceeds a determined or determinable value and/or when the second data reveal that the user is using a further device including a vehicle or a machine.

7. The method according to claim 1, wherein the step of ascertaining the safety relevance includes a determination of: (i) a probability of a collision of the user with the at least one object, and/or (ii) a probability of a particular degree of severity of a consequence of an accident for the user and/or for further persons in the environment of the user in the event of the collision of the user with the at least one object.

8. The method according to claim 1, wherein the output signal is output when the safety relevance of the at least one object exceeds a determined or determinable value.

9. The method according to claim 1, wherein the output of safety-relevant and non-safety-relevant information is information to be visually represented to the user via the AR device in a field of vision of the user, and, in the step of generating, the output signal is output to the AR device in such a way that non-safety-relevant information is represented only in subareas of the field of vision of the user that are outside an object visibility area, (i) in which subareas the user can visually detect the object and/or (ii) in which subareas no safety-relevant information regarding the at least one object is represented.

10. The method according to claim 1, wherein the safety-relevant information regarding the at least one object is output to the user in a visually and/or acoustically and/or haptically marked manner.

11. The method according to claim 1, wherein, before the step of generating, the output signal, a step of transforming takes place, wherein the at least one safety-relevant object in the environment of the user is continuously transformed into a coordinate system of the user and/or of the AR device.

12. The method according to claim 1, wherein the first data specify: (i) a type and/or nature of the at least one object, and/or (ii) an instantaneous distance between the user and the at least one object, and/or (iii) an instantaneous velocity of the at least one object, and/or a predicted trajectory of the object in the environment of the user.

13. The method according to claim 1, wherein the second data specify: (i) an instantaneous position of the user in their environment, and/or (ii) an instantaneous velocity of the user in their environment, and/or (iii) a predicted trajectory of the user in their environment.

14. A device for data processing, the device configured to ascertain a configuration of a user-state-dependent output of safety-relevant and non-safety-relevant information for a user of an AR device, the device configured to:
receive first data, wherein the first data are specific to at least one object in an indirect and/or direct environment of the user;
receive second data, wherein the second data are specific to the user;
ascertain a safety relevance of the at least one object to the user based on the first data and/or the second data;
ascertain a state of the user based on the second data; and
generate an output signal to the AR device depending on the ascertained safety relevance and the ascertained state of the user.

15. The device according to claim 14, wherein the device is a pair of AR glasses or as a head-up display or has a pair of AR glasses or has a head-up display.

16. A non-transitory computer-readable medium on which is stored a computer program including instructions for ascertaining a configuration of a user-state-dependent output of safety-relevant and non-safety-relevant information for a user of an AR device, the instructions, when executed by a computer, causing the computer to perform the following steps:
receiving first data, wherein the first data are specific to at least one object in an indirect and/or direct environment of the user;
receiving second data, wherein the second data are specific to the user;
ascertaining a safety relevance of the at least one object to the user based on the first data and/or the second data;
ascertaining a state of the user based on the second data; and
generating an output signal to the AR device depending on the ascertained safety relevance and the ascertained state of the user.
